(19) United States
(12) Patent Application Publication
(10) Pub. No.: US 2020/0166120 A1
(43) Pub. Date: May 28, 2020

(54) Chemically Pressurized Emergency Lubrication System

(71) Applicant: Bell Helicopter Textron Inc., Fort Worth, TX (US)

(72) Inventor: Tyson Henry, Arlington, TX (US)

(21) Appl. No.: 16/201,764

(22) Filed: Nov. 27, 2018

(51) Int. Cl. F16H 57/04; B64C 27/12

(52) U.S. Cl. CPC F16H 57/0442; B64C 27/12; F16H 57/0435; F16H 57/0456; F16H 57/0445; F16H 57/045

(57) ABSTRACT

Various implementations described herein are directed to an emergency lubrication system for an aircraft. The emergency lubrication system includes a lubrication chamber, a bladder, a gearbox, and a valve. The bladder is coupled to the lubrication chamber and includes one or more chemicals that pressurize the lubrication in the lubrication chamber when activated. The valve is coupled between the lubrication chamber and the gearbox and provides the lubrication to one or more components within the gearbox.

### STATEMENT REGARDING FEDERALLY SPONSORED RESEARCH OR DEVELOPMENT

Not applicable.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

In typical rotorcraft gearboxes, an emergency lubrication system may be activated in a loss of lubrication scenario. In these prior systems, when primary lubrication is lost, reserve lubrication is provided to the gearbox to allow time to land without significant gearbox failure. Prior art systems are only configured to provide a pre-set flow rate for oil provided to the gearbox for a pre-set amount of time until the supply of oil is exhausted.

### SUMMARY

Described herein are various implementations of an emergency lubrication system for an aircraft. The emergency lubrication system includes a lubrication chamber, a bladder, a gearbox, and a valve. The bladder is coupled to the lubrication chamber and includes one or more chemicals that pressurize the lubrication in the lubrication chamber when activated. The valve is coupled between the lubrication chamber and the gearbox and provides the lubrication to one or more components within the gearbox.

Upon activation of the valve, the emergency lubrication system is configured to provide lubrication from the lubrication chamber in a low pressure mode and a high pressure mode. In one implementation, the lubrication is provided from the lubrication chamber to the gearbox based on head pressure in the low pressure mode. In one implementation, the lubrication is provided from the lubrication chamber to the gearbox in the high pressure mode to increase a cooling capability of the emergency lubrication system.

The emergency lubrication system may include an igniter disposed within the bladder. The igniter may activate the one or more chemicals by igniting the one or more chemicals in the bladder. A plurality of criteria may be used to determine when the igniter is activated. The plurality of criteria may include a mode of operation and/or a temperature.

In one implementation, a plurality of bladders is coupled to the lubrication chamber and pressure of the lubrication is varied by igniting the one or more chemicals present in one or more of the plurality of bladders.

The emergency lubrication system may include one or more jets coupled to the valve between the gearbox and the lubrication chamber. In one implementation, the one or more jets feed a high-speed component within the gearbox.

In one implementation, the one or more chemicals create an exothermic reaction when ignited. The exothermic reaction can produce a predetermined volume of pressurized gas that can be used to pressurize the lubrication provided to one or more components within the gearbox.

In one implementation, a solenoid is used to open the valve.

Also described herein are various implementations of a method for providing an emergency lubrication for an aircraft. A valve is actuated upon an indication of a loss of lubrication event. Lubrication is provided to a gearbox via the valve based on head pressure in a low pressure mode. Lubrication is provided to the gearbox via the valve in high pressure mode by activating one or more chemicals in one or more bladders coupled to the gearbox.

In one implementation, each of the one or more bladders includes an igniter that activates the one or more chemicals present in each of the one or more bladders. A plurality of criteria may be used to determine when the igniter is activated. The plurality of criteria may include one or more of: a mode of operation and a temperature.

Also described herein are various implementations of an emergency lubrication system for a rotorcraft. The emergency lubrication system includes one or more lubrication chambers, one or more bladders, one or more gearboxes, and one or more valves. The one or more bladders are coupled to the one or more lubrication chambers. Each of the one or more bladders includes one or more chemicals that pressurize lubrication in the one or more lubrication chambers when activated. The one or more valves are coupled between each of the one or more lubrication chambers and the one or more gearboxes and provides the lubrication to one or more components within each of the one or more gearboxes.

In one implementation, upon activation of the one or more valves, the emergency lubrication system is configured to provide the lubrication from the one or more lubrication chambers in a low pressure mode and a high pressure mode.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 is an oblique top right view of an aircraft according to the disclosure with the aircraft in a cruise configuration.

FIG. 2 is a front view of the aircraft of FIG. 1 in a cruise configuration.

FIG. 3 is an oblique top right view of the aircraft of FIG. 1 with the aircraft in a vertical takeoff and landing (VTOL) configuration.

FIG. 4 is a front view of the aircraft of FIG. 1 with the aircraft in a VTOL configuration.

FIG. 5 is an oblique top right view of the aircraft of FIG. 1 with the aircraft in a folded configuration.

FIG. 6 is a front view of the aircraft of FIG. 1 with the aircraft in a folded configuration.

FIG. 7 is a top view of the aircraft of FIG. 1 with the aircraft in a folded configuration.

FIG. 8 illustrates a rotorcraft in accordance with implementations of various techniques described herein.

FIG. 9 illustrates a rotorcraft in accordance with implementations of various techniques described herein.

FIG. 10 illustrates an emergency lubrication system in accordance with implementations of various techniques described herein.

FIG. 11 illustrates a diagram of a method for providing an emergency lubrication system in accordance with implementations of various techniques described herein.

### DETAILED DESCRIPTION

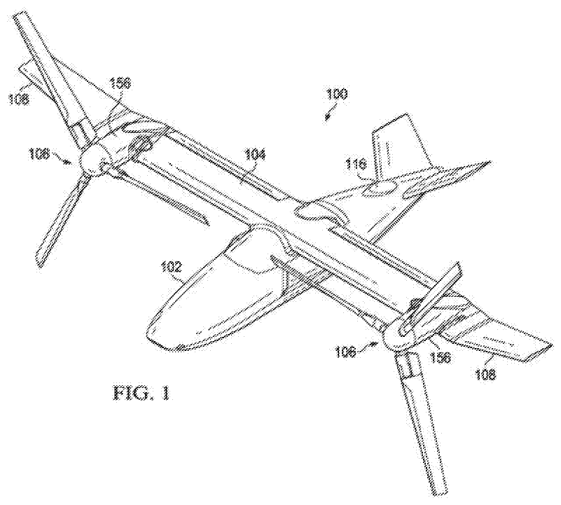

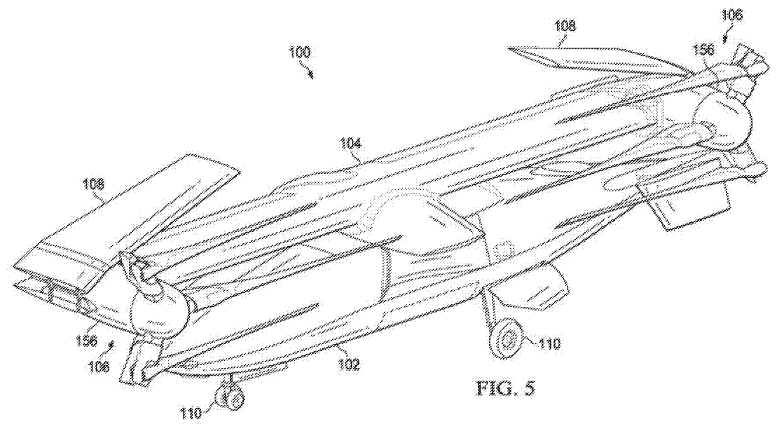

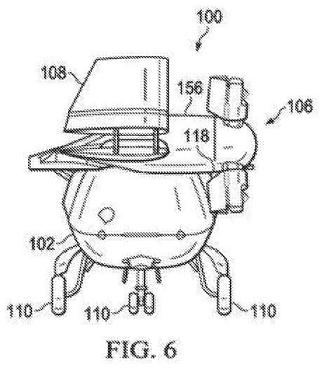

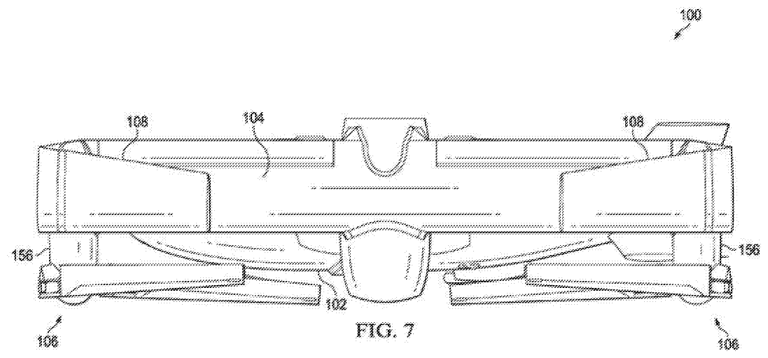

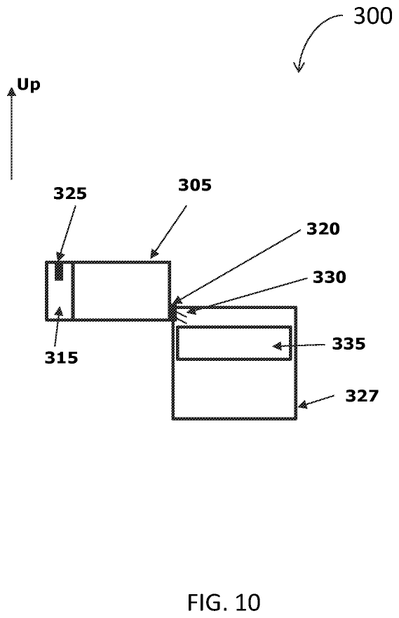

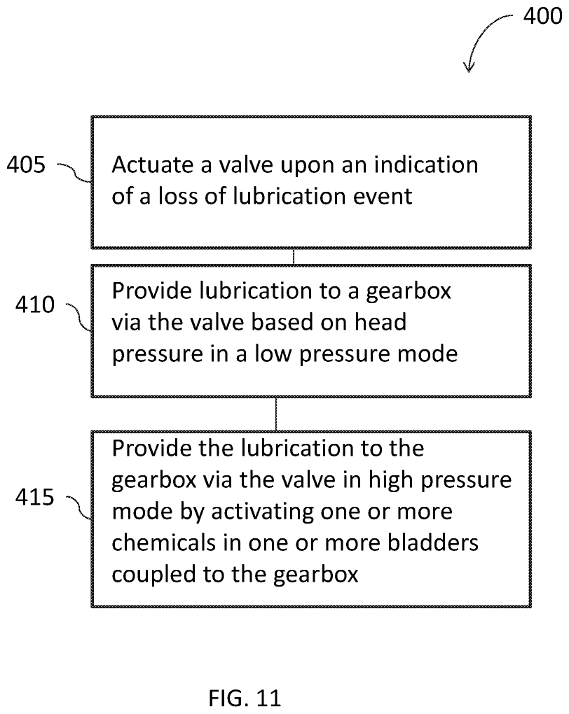

The following description provided in FIGS. 1-9 describes example rotorcraft where the implementations of FIG. 10 and FIG. 11 may be implemented. The implementations described herein may be applied to other types of aircraft, e.g., fixed-wing, rotorcraft, and tiltrotor rotorcraft, and are not limited to the aircraft described in FIGS. 1-9.

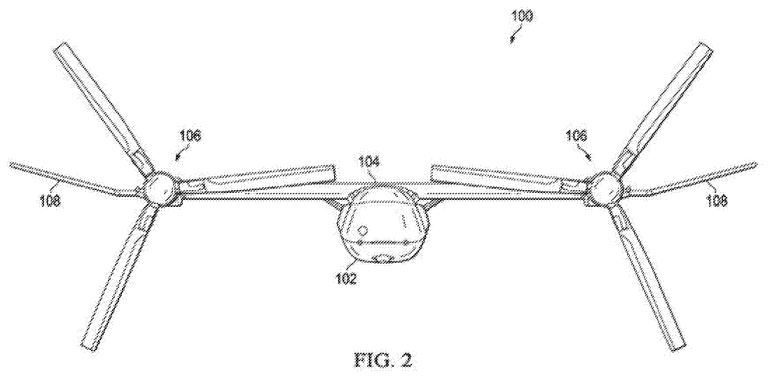

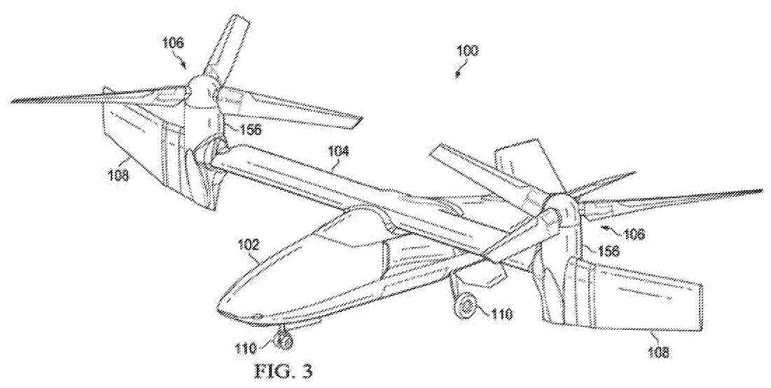

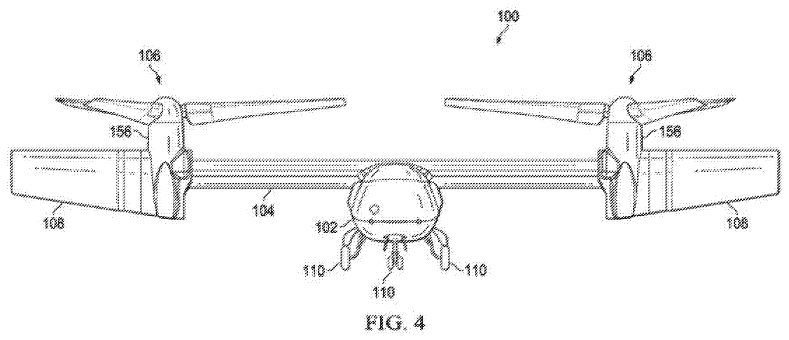

Referring to FIGS. 1-7 in the drawings, an aircraft 100 is illustrated. The aircraft 100 comprises a tiltrotor unmanned aerial vehicle (UAV). The aircraft 100 comprises a fuselage 102, a wing 104, rotor systems 106, foldable wing extensions 108, and landing gear 110. The aircraft 100 is generally operable in a cruise mode as shown in FIGS. 1 and 2 in which the aircraft 100 orients the rotor systems 106 and wing extensions 108 to allow flight in a manner substantially similar to a fixed wing aircraft. The aircraft 100 is also operable in a vertical takeoff and landing (VTOL) mode as shown in FIGS. 3 and 4 in which the aircraft 100 orients the rotor systems 106 and wing extensions 108 to allow vertical takeoff and landing in a manner substantially similar to a helicopter. In this embodiment, the aircraft 100 can also operate in a transition mode in which the rotors systems 106 and wing extensions 108 are oriented in positions between the positions shown in the cruise mode and the VTOL mode. Although a (UAV) is shown and described, the present disclosure may be applied to any manned or unmanned tiltrotor aircraft. In addition, although a gearbox is not shown for aircraft 100, a gearbox may be situated near each rotor system 106 similar to the configuration described below for gearbox 327 and main rotor mast 117.

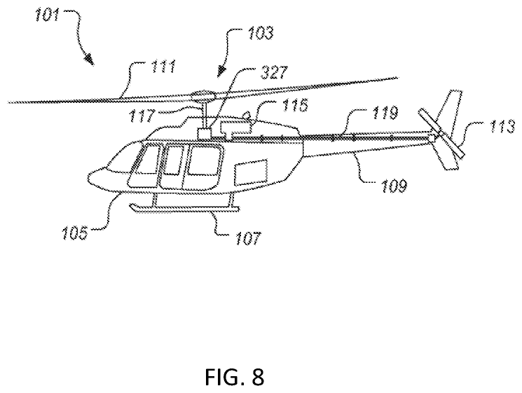

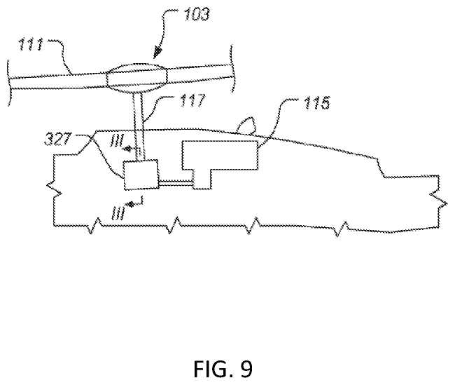

FIG. 8 and FIG. 9 illustrate a rotorcraft 101 according to one implementation. Rotorcraft 101 has a rotor system 103 with a plurality of main rotor blades 111. Rotorcraft 101 further includes a fuselage 105, landing gear 107, a tail member 109, and tail rotor blades 113. An engine 115 supplies torque to a main rotor mast 117 via a gearbox 327 for the rotating of main rotor blades 111. Engine 115 also supplies torque to a tail rotor drive shaft 119 for the rotating of tail rotor blades 113. The pitch of each main rotor blade 111 can be selectively controlled in order to selectively control direction, thrust, and lift of rotorcraft 101. Further, the pitch of tail rotor blades 113 can be selectively controlled in order to selectively control yaw of rotorcraft 101. Rotorcraft 101 is illustrated for exemplary purposes. It should be appreciated that implementations of the present disclosure may be used on aircraft other than rotorcraft, e.g., airplanes, tilt rotors, or unmanned aircraft. Further, implementations of the present disclosure may be used on non-aircraft vehicles.

FIG. 10 illustrates an emergency lubrication system 300. FIG. 10 includes an emergency lubrication system 300 for an aircraft, e.g., rotorcraft 101. The emergency lubrication system 300 includes a lubrication chamber 305, one or more bladders 315, a gearbox 327, a valve 320, and a jet/orifice 330. The one or more bladders 315 are included within or coupled to the lubrication chamber 305. The one or more bladders 315 each include one or more chemicals that pressurize the lubrication in the lubrication chamber 305 when activated using igniter 325. The lubrication chamber 305 is coupled to the gearbox 327 via valve 320. Jet/orifice 330 is coupled to valve 320 and is used to provide lubrication to one or more components 335 within gearbox 327.

A loss of lubrication event can be initiated manually or automatically, e.g., using valve 320. In one implementation, valve 320 may be opened using a solenoid. The emergency lubrication system 300 operates in different modes. The emergency lubrication system is configured to operate in a low pressure mode, e.g., drip mode, or high pressure mode depending on whether or not criteria for activating igniter 325 has been met. Lubrication is provided from the lubrication chamber 305 to the gearbox 327 in the high pressure mode to increase a cooling capability of the emergency lubrication system.

In one implementation, the lubrication may be provided from the lubrication chamber 305 to the gearbox 327 based on head pressure alone in the low pressure mode. In one implementation, valve 320 may be a one-way check valve that allows air to enter during drip mode or low pressure mode and air and/or gas to enter during a high pressure mode. While in low pressure mode, little to no pressure is required to allow lubrication to drip from the lubrication chamber 305 to the gearbox 327.

As described above, the one or more chemicals in each bladder 315 may be activated by the igniter 325 disposed within each bladder 315. Igniter 325 activates the one or more chemicals by igniting the one or more chemicals in the bladder 315.

The one or more chemicals create an exothermic reaction when ignited by igniter 325. The exothermic reaction produces a predetermined volume of pressurized gas that is used to pressurize the lubrication provided to the one or more components 335 within the gearbox 327.

In one implementation, one or more factors/criteria may be used to determine when the igniter is activated. The criteria may include a mode of operation, a temperature (e.g., within the gearbox) or some other factor.

In one implementation, when more than one bladder is used, a pressure of the lubrication can be varied by igniting the one or more chemicals present in one or more of the bladders.

Jet/orifice 330 is coupled to the valve 320 between the gearbox 327 and the lubrication chamber 305. Jet 330 feeds pressurized or non-pressurized lubrication to one or more components 335 within the gearbox 327. The one or more components 335 may be high-speed components that include gears, gear meshes, planetary gears, bearings and/or any other rotating component within the gearbox 327.

FIG. 11 illustrates a method 400 for providing an emergency lubrication system in an aircraft, e.g., rotorcraft 101. At block 405, a valve, e.g., valve 320, is actuated upon an indication of a loss of lubrication event. The loss of lubrication event can be initiated manually or automatically. In one implementation, valve 320 may be actuated, i.e., opened, using a solenoid.

At block 410, lubrication is provided to a gearbox 327 via valve 320 based on head pressure in a low pressure mode. In low pressure mode, very little or no pressure is required to allow lubrication to drip from the lubrication chamber 305 to the gearbox 327.

At block 415, lubrication is provided to the gearbox 327 via valve 320 in high pressure mode by activating one or more chemicals in one or more bladders 315 coupled to the gearbox 327. In the high pressure mode, the cooling capabilities of the emergency lubrication are increased due to the increase in lubrication entering the gearbox 327.

The one or more chemicals in each bladder produce an exothermic reaction upon activation, i.e., by igniter 325. The exothermic reaction produces pressurized gas that is used to pressurize the lubrication and increase the flow of lubrication provided to the one or more components within the gearbox 327.

One or more factors/criteria may be used to determine when the igniter 325 is ignited to activate the one or more chemicals. The criteria may include a mode of operation and/or a temperature. In one implementation, the pressure of the lubrication may be varied by igniting one or more bladders 315.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly“; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An emergency lubrication system for an aircraft, comprising:
a lubrication chamber;
a bladder coupled to the lubrication chamber, wherein the bladder includes one or more chemicals that pressurize the lubrication in the lubrication chamber when activated;
a gearbox; and
a valve coupled between the lubrication chamber and the gearbox that provides the lubrication to one or more components within the gearbox.

2. The emergency lubrication system of claim 1, wherein upon activation of the valve, the emergency lubrication system is configured to provide lubrication from the lubrication chamber in a low pressure mode and a high pressure mode.

3. The emergency lubrication system of claim 2, wherein the lubrication is provided from the lubrication chamber to the gearbox based on head pressure in the low pressure mode.

4. The emergency lubrication system of claim 2, wherein the lubrication is provided from the lubrication chamber to the gearbox in the high pressure mode to increase a cooling capability of the emergency lubrication system.

5. The emergency lubrication system of claim 1, further comprising an igniter disposed within the bladder.

6. The emergency lubrication system of claim 5, wherein the igniter activates the one or more chemicals by igniting the one or more chemicals in the bladder.

7. The emergency lubrication system of claim 6, wherein a plurality of criteria are used to determine when the igniter is activated.

8. The emergency lubrication system of claim 7, wherein the plurality of criteria includes a mode of operation.

9. The emergency lubrication system of claim 7, wherein the plurality of criteria includes a temperature.

10. The emergency lubrication system of claim 1, wherein a plurality of bladders is coupled to the lubrication chamber and pressure of the lubrication is varied by igniting the one or more chemicals present in one or more of the plurality of bladders.

11. The emergency lubrication system of claim 1, further comprising one or more jets coupled to the valve between the gearbox and the lubrication chamber.

12. The emergency lubrication system of claim 11, wherein the one or more jets feed a high-speed component within the gearbox.

13. The emergency lubrication system of claim 1, wherein the one or more chemicals create an exothermic reaction when ignited.

14. The emergency lubrication system of claim 13, wherein the exothermic reaction produces a predetermined volume of pressurized gas that is used to pressurize the lubrication provided to one or more components within the gearbox.

15. The emergency lubrication system of claim 1, wherein a solenoid is used to open the valve.

16. The emergency lubrication system of claim 1, wherein the valve comprises a one-way check valve.

17. A method for providing emergency lubrication for an aircraft, comprising:
actuating a valve upon an indication of a loss of lubrication event;
providing lubrication to a gearbox via the valve based on head pressure in a low-pressure mode;
providing the lubrication to the gearbox via the valve in high pressure mode by activating one or more chemicals in one or more bladders coupled to the gearbox.

18. The method of claim 17, further comprising using a plurality of criteria to determine when an igniter within each of the one or more bladders is activated.

19. A rotorcraft comprising an emergency lubrication system, the emergency lubrication system comprising:
one or more lubrication chambers;
one or more bladders coupled to the one or more lubrication chambers, wherein each of the one or more bladders includes one or more chemicals that pressurize lubrication in the one or more lubrication chambers when activated;
one or more gearboxes; and
one or more valves coupled between each of the one or more lubrication chambers and the one or more gearboxes that provide lubrication to one or more components within each of the one or more gearboxes.

20. The rotorcraft comprising the emergency lubrication system of claim 19, wherein upon activation of the one or more valves, the emergency lubrication system is configured to provide the lubrication from the one or more lubrication chambers in a low pressure mode and a high pressure mode.
